(19) United States
(12) Patent Application Publication
(10) Pub. No.: US 2015/0308388 A1
(43) Pub. Date: Oct. 29, 2015

(54) Built-In Exhaust Gas Maintenance Device

(71) Applicants: BorgWarner Emissions Systems Spain, S.L.U, Vigo-Pontevedra (ES); BorgWarner Emissions Systems Spain, S.L.U, Vigo-Pontevedra (ES)

(72) Inventors: Carlos Manuel Castaño Gonzalez, Vigo (ES); Sonia Civeira Dominguez, Vigo (ES)

(73) Assignee: BorgWarner Emissions Systems Spain, S.L.U.

(21) Appl. No.: 14/651,465

(22) PCT Filed: Dec. 10, 2013
(86) PCT No.: PCT/EP2013/076063

§ 371 Date: Jun. 11, 2015

(30) Foreign Application Priority Data
Dec. 11, 2012 (EP) 12382491.4

(51) Int. Cl. F02M 25/07

(52) U.S. Cl. CPC F02M 25/0734

(57) ABSTRACT

The present invention relates to a gas management device suitable for being installed at the outlet o fa particle filter or of a catalytic converter. This device is characterized by a very compact configuration having at least the heat exchanger for an EGR (Exhaust Gas Recirculation) system, particularly suitable for a low pressure system, and an exhaust gas discharge pipe which is part of the exhaust line. According to one embodiment, the device also allows integrating a bypass valve for the EGR heat exchanger. According to another embodiment, the device allows integrating a heat recovery unit participating in the EGR system. According to another embodiment, the device also allows both including a bypass and including a heat recovery unit. The degree of integration with the particle filter of the catalytic converter is maintained in all cases.

### OBJECT OF THE INVENTION

The present invention relates to a gas management device suitable for being installed at the outlet of a particle filter or of a catalytic converter. This device is characterized by a very compact configuration having at least the heat exchanger for an EGR (Exhaust Gas Recirculation) system, particularly suitable for a low pressure system, and an exhaust gas discharge pipe which is part of the exhaust line.

According to one embodiment, the device also allows integrating a bypass valve for the EGR heat exchanger. According to another embodiment, the device allows integrating a heat recovery unit participating in the EGR system. According to another embodiment, the device also allows both including a bypass and including a heat recovery unit. The degree of integration with the particle filter of the catalytic converter is maintained in all cases.

### BACKGROUND OF THE INVENTION

One of the most intensively developing fields of technology is the EGR system technology for combustion heat engines because the recirculation of an exhaust gas requires solving various technical problems in terms of the demands imposed by the handling of a high temperature gas which contains corrosive products, which has condensate-generating possibility, and which also further contains particles that can damage sensitive engine parts.

In this scenario, each of the necessary functions in an EGR system is handled by a component dedicated to performing said function. The increase in the number of suitable components for particular technical problems and components with additional functions in EGR gas management requires increased space requirements and, since the engine compartment in a vehicle is limited, the solutions used today seek to increase the degrees of packaging.

This increased packaging is obtained by searching for cavities and gaps where the different devices provided with a configuration adapted to the space available are arranged without considerably impairing their operation. These devices are communicated with pipes establishing fluid connection (EGR gas pipes or coolant liquid pipes for example) with the point of the circuit where an inlet or an outlet is to be incorporated in a specific circuit or system.

One of the examples of devices requiring packaging solutions is the heat exchanger of an EGR system (EGR cooler). Once located in a suitable place and with a suitable orientation to meet the packaging requirements, the EGR heat exchanger requires inlet pipes coming from the exhaust outlet and from the discharge pipes for cooled gas which is directed towards the intake with the interposition of an EGR valve for managing recirculated gas flow.

Low pressure systems are systems in which the EGR system is of the low pressure side with respect to the compressor-turbine group.

Particularly, low pressure EGR systems use a catalytic converter, a particle filter mainly to retain carbon build-up or both. In addition to these filters, there are other filters commonly known as emergency filters which prevent very hard solid particles, such as for example, ceramic particles that detached from the preceding filters, from reaching the turbine blades of the turbo compressor. The turbine blades are particularly sensitive and the introduction of solid particles causes serious damage in this device. Throughout the text, when indication is made only to a particle filter or a particulate filter or a catalytic converter, it refers to the first filters mentioned above unless otherwise indicated.

The solution used in the state of the art requires pipes which establish a connection between the outlet of the particle filter or of the catalytic converter and the inlet of the EGR heat exchanger; and also between the outlet of the EGR heat exchanger with the engine intake, usually with the interposition of the EGR valve.

Although this configuration allows a specific degree of packaging, it involves using pipes which also occupy a large space.

The present invention solves the problem of using pipes and of obtaining a higher degree of packaging by integrating the EGR heat exchanger with the catalytic converter or with the particle filter establishing a particular heat exchanger structure such that it is adapted to the large diameter of either the outlet of the catalytic converter or the outlet of the particle filter. This integration also incorporates the presence of a segment of discharge pipe as part of the exhaust line.

### Description of the Invention

The device according to the invention relates to a built-in exhaust gas management device suitable for being installed at the outlet of a particulate filter or a catalytic converter of a low pressure EGR system. This integration is achieved because the device has a built-in EGR heat exchanger in said outlet and with a segment of exhaust discharge pipe using a particular configuration comprising:
A first baffle with coupling means suitable for covering the outlet of a particulate filter or a catalytic converter.

This first baffle covers the outlet of the particulate filter or of the catalytic converter so it receives all the hot exhaust gases and prevents the use of an outlet manifold of this device.

At least two types of pipes that reach this baffle, the pipes of the EGR heat exchanger and the exhaust gas discharge pipe, will later be introduced. The attachment of the baffle with each pipe arriving at said baffle through one of the sides is made through a perforation in said baffle such that a fluid communication is established between the inside of the pipe and the space located on the other side of the baffle. Corrugated tubes will be shown in the embodiments; nevertheless, the invention can be carried out using other types of tube differing in shape, number and size, depending on the thermal requirements of each specific design. Other examples of tubes to be used are tubes with an elliptical section or hybrid tubes with inner fins to improve heat transfer.

The pipes which are attached to the first baffle transport the hot gas coming from the catalytic converter or from the particle filter. This baffle has an area that is the same as or very close to the outlet area of the catalytic converter or of the particulate filter. This area is large compared with the section of other devices. The present invention distributes part of this section for the entry into the heat exchanger and part for the exit of non-cooled exhaust gases.
A second baffle spaced from the first baffle,
a first perimetral casing extending between the first baffle and the second baffle such that it defines a first chamber intended for housing a coolant fluid.

The chamber intended for housing the coolant liquid is formed by two preferably parallel baffles spaced from one another and surrounded by the first perimetral casing. The preferred configuration of the invention is a prolongation of the particulate filter or of the catalytic converter. According to preferred examples of the invention, the baffles are essentially arranged transverse to the longitudinal direction defined by the particulate device or the catalytic converter to which it is attached and the casing prolongs the casing of the same device. Nevertheless, this is not the only way of carrying out the invention since the demands for space (packaging) may require this prolongation to not be longitudinal but rather to show a specific angle with respect to the particulate device or the catalytic converter on which it is installed. This is the case of incorporating a coupling seat with an angle of inclination.
A second casing arranged covering at least part of the surface of the second baffle opposite the surface oriented to the first chamber such that a second chamber for collecting cooled exhaust gases is defined,
one or more cooling pipes housed inside the first chamber where each pipe is attached at one end to the first baffle and at the second end to the second baffle such that it communicates the outlet of the particle filter or catalytic converter with the second chamber for the passage and cooling of the exhaust gases passing therethrough,
an inlet and an outlet of the first chamber for the passage of coolant fluid through the first chamber.

The heat exchanger is configured in the chamber formed by the first baffle, the second baffle and the casing. This chamber contains the coolant fluid circulating as a result of the inlet and outlet which allows the connection with the cooling circuit removing the heat transferred by the cooling pipes which are also housed inside this first chamber. The arrangement of the cooling pipes is such that they extend communicating the outlet of the particulate filter or the catalytic converter with the second chamber.

This configuration based on a first baffle having coupling means suitable for being coupled to the outlet of the particulate filter or the catalytic converter gives rise to a heat exchanger which is a continuation of said particulate filter or catalytic converter without being mediated by a connection pipe connecting the devices.

Even though the collection of exhaust gases is common to the first baffle, the second baffle has a second chamber by means of a second casing that is limited to collecting cooled gases so that they are not in communication with the non-cooled gases.
The first baffle shows a first area in which the cooling pipes are distributed and a second area free of cooling pipes; and,
a segment of exhaust pipe attached to the first baffle through the second area free of pipes in communication with the outlet of the particulate filter or catalytic converter for the exit of exhaust gases.

According to this technical feature, the attachment of the pipes to the first baffle is established on an area of said first baffle showing a distribution which allows differentiating the group of pipes and an area free of pipes. The first area where the cooling pipes are distributed establishes the region where the heat of the exhaust gas is transferred to the coolant liquid along the length of said pipes. The second area is that which contains a segment of exhaust pipe intended for the passage of the exhaust gas which does not pass through the heat exchanger.

According to various embodiments, even though the first baffle requires differentiating these areas, the second baffle does not require this limitation. For example, the second casing can be limited to the area of the second baffle receiving the ends of the cooling pipes collecting the cooled gases leaving the segment of exhaust gas discharge pipe independent. In turn, unlike the first baffle the second baffle does not need to extend into an area free of cooling pipes. Notwithstanding the foregoing, the preferred example of the invention extends the area of the second baffle leaving the segment of exhaust pipe to also extend from the first baffle to the second baffle and additionally leaving the second chamber to be traversed by the segment of exhaust pipe.
The second chamber has a cooled gas outlet intended for reaching the engine intake.

The outlet of this chamber provides an already cooled exhaust gas suitable for being reintroduced directly in the intake managed by the EGR valve.

The invention provides a device incorporating a built-in EGR heat exchanger as well as direct outlets to the exhaust and to the EGR valve for gas recirculation where said device can be coupled directly on the particle filter or catalytic converter.

### DESCRIPTION OF THE DRAWINGS

The foregoing and other features and advantages of the invention will be more clearly seen from the following detailed description of a preferred embodiment, given only by way of illustrative and non-limiting example in reference to the attached drawings.

FIG. 1 schematically shows a first embodiment of the invention. This schematic depiction corresponds to a section of the device according to a mid-plane passing through the longitudinal direction X-X′ defined by the body of the particulate filter or catalytic converter, where an EGR valve is also shown as the destination of the gas cooled by the built-in EGR heat exchanger. This figure does not show the particulate filter or catalytic converter in order to assign almost the entire graphical depiction area to the device according to the embodiment.

FIG. 2 shows a second embodiment with a section taken in a position and orientation similar to that used in the view of the preceding figure. In this second embodiment, the device incorporates a bypass valve.

FIG. 3 shows a third embodiment with a section taken in a position and orientation similar to that used in the view of the preceding figure. In this third embodiment, the device incorporates a valve allowing heat recovery.

FIG. 4 shows a fourth embodiment with a section taken in a position and orientation similar to that used in the view of the preceding figure. In this fourth embodiment, the device incorporates two valves which allow achieving both the EGR heat exchanger bypass and heat recovery.

FIG. 5 shows a modification of the first embodiment defining a three-phase exchanger. This modification is applicable to any of the preceding embodiments.

### DETAILED DESCRIPTION OF THE INVENTION

According to the first inventive aspect, the present invention relates to a built-in exhaust gas management device suitable for being attached to the outlet of a particulate filter or a catalytic converter.

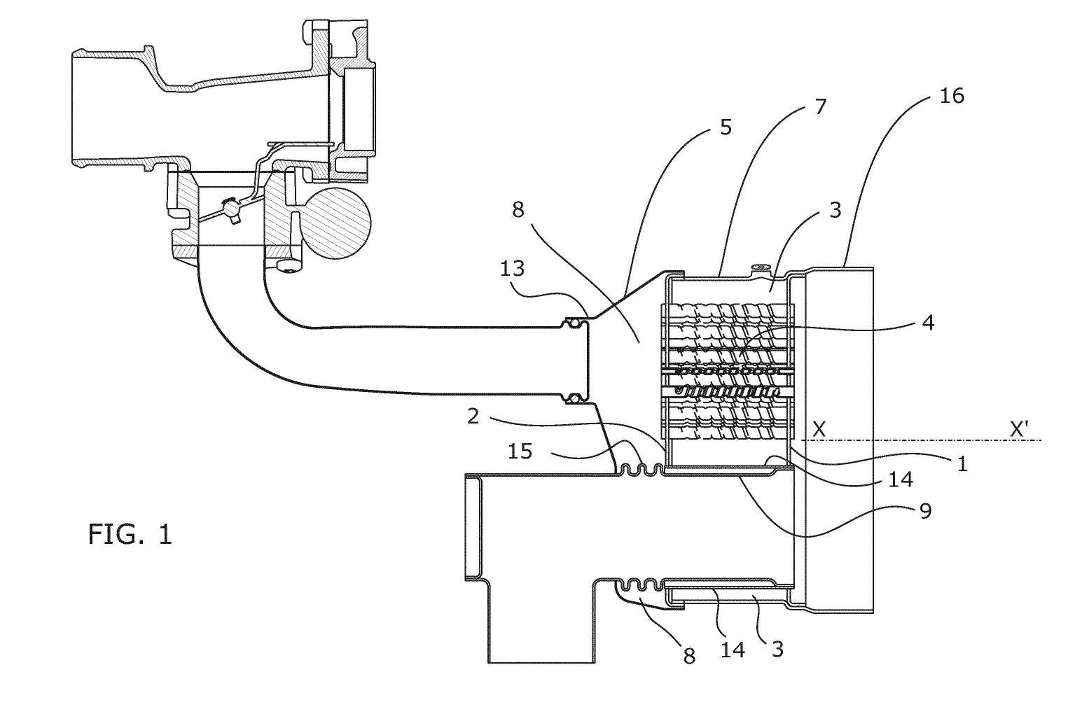

FIG. 1 shows a first embodiment of the invention, a device suitable for being attached to a particle filter or a catalytic converter. The particle filter or catalytic converter is not shown to make space for the device according to this embodiment, nevertheless, the longitudinal direction X-X′ defined by the particle filter or catalytic converter is indicated.

Throughout this detailed description with the support of the drawings, relative terms such as right or left will be used referring to the orientation used in the arrangement of the drawings. Such terms, taking into account the device orientation, are equivalent to terms corresponding to the longitudinal direction X-X′ or with respect to other parts of said device. Terms such as right, left, above or below are used to facilitate the description.

The particle filter or catalytic converter has an outlet with a large diameter which is covered by a first baffle (1) having coupling means (16) configured for surrounding the outlet of the particle filter or catalytic converter covering it. These coupling means (16) allow attaching the device according to the invention with the particle filter or catalytic converter.

In this embodiment, the first baffle (1) is obtained by means of a stamped aluminum sheet with the edges on its perimeter bent. Following the orientation shown in FIG. 1, a second baffle (2) spaced from the first baffle (1) is shown to the left of the first baffle (1). In this example, the first baffle (1) and the second baffle (2) are arranged parallel to one another.

A first perimetral casing (7) extends between the first baffle (1) and the second baffle (2) defining a first chamber (3) intended for housing a coolant fluid, preferably a liquid. Particularly, this first casing (7) has been configured according to a tubular body with dual stepping, a first stepping housing the first baffle (1) and a second stepping giving rise, by way of the extension of the tubular body, to the coupling means (16) suitable for surrounding the particulate filter or the catalytic converter.

Another alternative option uses a shorter first casing (7). In this alternative, the first baffle (1) would be shown in symmetrical arrangement with respect to the second baffle (2); i.e., the perimetral bending would be oriented in opposition to the orientation shown by the perimetral bending of the second baffle (2), both being fitted in the first casing (7). In this case, the coupling means (16) would be an independent part welded to the body formed by the first baffle (1) and the first casing (7). This alternative option allows configuring the part forming the coupling means (16) with an angle which in turn results in a seat that is oblique with respect to the longitudinal direction defined by the particulate filter or the catalytic converter on which it is attached.

With this configuration, the first baffle (1) and the coupling means (16) collect all the gases exiting the particulate filter or catalytic converter surrounded by the coupling means (16). Therefore, the gases exiting the particulate filter or the catalytic converter can only circulate through the pipes which are attached to the first baffle (1).

The second baffle (2) has also been configured by means of a stamped layer with bent edges on its perimeter except in this case it has been coupled to the tubular body formed by the first casing (7) externally surrounding it at the end shown to the left.

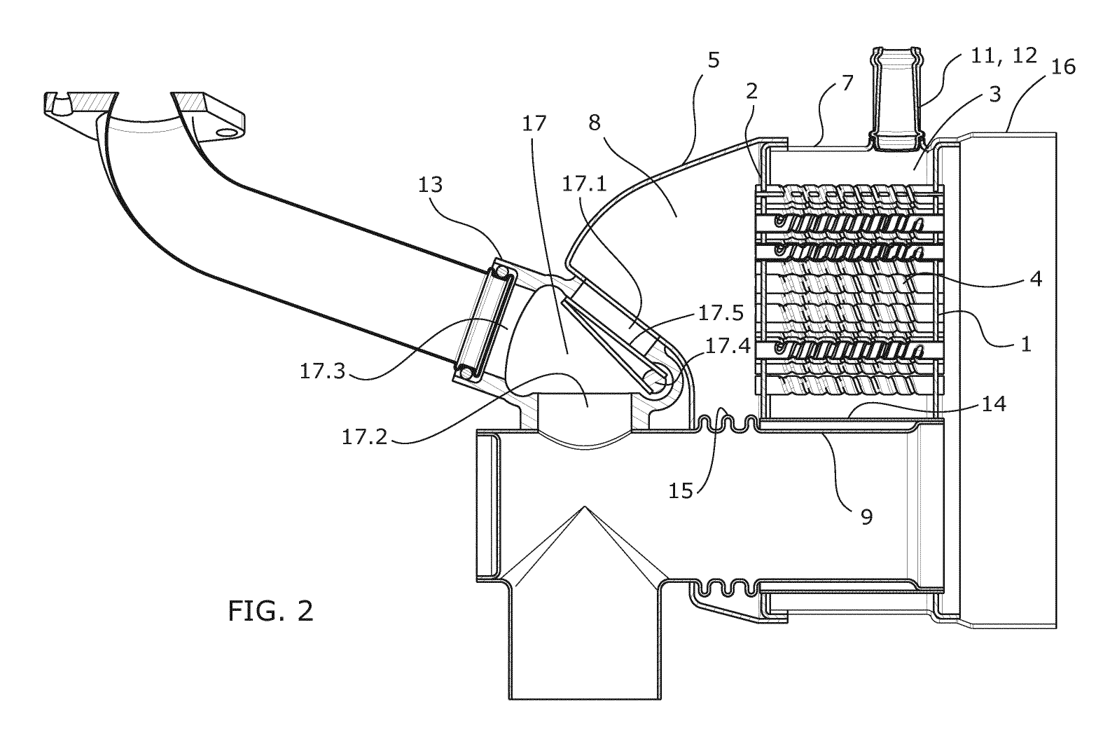

Both the first baffle (1) and the second baffle (2) have perforations housing the ends of a plurality of cooling pipes (4). Each of these cooling pipes (4) puts the gas outlet of the particulate filter or of the catalytic converter in fluid communication; i.e., the space located to the right of the first baffle (1) with the space located to the left of the second baffle (2). In this embodiment, the cooling pipes (4) are corrugated tubes for increasing the heat exchange between the gas circulating through the inside of the cooling pipe (4) and the coolant fluid covering it externally in an operating mode. The first chamber (3) has an inlet and an outlet (11, 12) not shown in this FIG. 1 but shown in FIG. 2. The sectioning of each of the drawings may or may not show a partial intersection with the inlet or outlet (11, 12) depending on if the section plane coincides with said inlet or outlet (11, 12).

The second baffle (2) is in turn covered by a second casing (5) surrounding the edges of the second baffle (2) on the perimeter. This second casing (5) forms a second chamber (8) and collects the gases exiting the cooling pipes (4) after having been cooled by transferring heat from the gas to the coolant liquid. The cooled gases can exit through an outlet (13) which, for example, can reach an EGR valve that is shown in the preceding figure to the left for being introduced in the engine intake again.

The plurality of cooling pipes (4) is grouped in the upper area such that in the first baffle (1) there is an area with ends of cooling pipes (4) and another area, in the lower part, free of cooling pipes (4). This second area is occupied by a segment of exhaust pipe (9) allowing the exit of the exhaust gases without them having to pass through the EGR heat exchanger made up, among others, of the cooling pipes (4).

In this embodiment, the segment of exhaust pipe (9) is in turn housed in a pipe with greater dimensions (14) giving rise to a separation chamber separating the segment of exhaust pipe (9) and the first chamber (3).

Since the exhaust pipe (9) in this embodiment extends at least from the first baffle (2) to the second baffle passing through the inside of the first chamber (3) a compact configuration is achieved given that the perimeter limits of the particle filter or catalytic converter are not exceeded in projection according to the longitudinal direction X-X′ due to the existence of an additional pipe.

Given that in this embodiment, at least the segment of exhaust pipe (9) passing through the inside of the first chamber (3) has been thermally insulated, heat transfer from the exhaust gases which are not necessarily cooled gases to the coolant liquid where this heat must in turn be discharged by the engine radiator, is prevented. The use of two coaxial pipes, the pipe with greater dimensions (14) and the exhaust pipe (9), provides a simple construction for obtaining this thermally insulated segment.

In this embodiment, the second casing (5) covers the perimeter of the second baffle (2) which coincides in projection according to the longitudinal direction X-X′ with the first baffle (1) such that the segment of exhaust pipe (9) traverses the second chamber (8) for being prolong in the exhaust line. The segment of exhaust pipe (9) located inside the second chamber (8) comprises a portion configured in the form of a bellows (15) for absorbing expansion stresses. This segment of pipe traversing the second chamber (8) is subjected to two different temperatures, the temperature of the cooled gas and the temperature of the non-cooled gas. When the device is not operating all the parts are cold and are therefore at the same temperature, nevertheless, in an operating mode the temperatures are different so this temperature difference causes stresses due to differentiated expansions as well.

To prevent excessive stresses due to differentiated expansion, this solution allows maintaining the degree of integration even though the pipe passes through the second chamber.

As shown throughout, in this embodiment both the cooling pipes (4) and the exhaust pipe (9) are arranged essentially parallel to one another and to the longitudinal direction X-X′. This orientation favors using the diameter of the particle filter or catalytic converter.

FIG. 2 shows a second embodiment comprising the same elements as the first example shown in the already described FIG. 1, and additionally comprises a bypass valve (17).

The exhaust pipe (9), prolonged outside the second casing (5), has an opening. The second casing (5) has been modified such that the cooled gas outlet (13) has an oblique exit direction directed towards the exhaust pipe (9), particularly close to the position of the opening of the exhaust pipe (9). The bypass valve (17) has a first inlet (17.1) in connection with the cooled gas outlet (13) of the second chamber (8), a second inlet (17.2) in connection with the opening of the prolongation of the segment of exhaust pipe (9); and an outlet (17.3) which is in fluid communication with the intake, for example, through an EGR valve.

The bypass valve (17) allows at least two end positions:
a first position where the first inlet (17.1) is contacted with the outlet (17.3) keeping the second inlet (17.2) closed; and,
a second position where the second inlet (17.2) is contacted with the outlet (17.3) keeping the first inlet (17.1) closed.

In this embodiment, the bypass valve (17) has been configured by means of a flap (17.5) pivoting about a shaft (17.4) where the shaft (17.4) has two planar plates, one suitable for acting as a seat in the first inlet (17.1) of the bypass valve (17) and the other for acting as a seat in the second inlet (17.2) of the bypass valve (17).

The first end position of the flap (17.5) establishes fluid communication between the second chamber (8) and the pipe exiting towards the engine intake and keeps the communication with the segment of exhaust pipe (9) closed. In this end position the device operates like in the first embodiment. Part of the exhaust gases exiting the particulate filter or the catalytic converter circulate through the heat exchanger made up of the cooling pipes (4) and reach the EGR valve (not shown in this figure) for being reintroduced in the engine intake. The other part of the exhaust gases exit directly through the segment of exhaust pipe (9) continuing through the exhaust line.

In the second end position of the flap (17.5) the outlet of the cooled gases is closed so the flow through the cooling pipes (4) is prevented and the entire flow exiting the particulate filter or the catalytic converter is forced to exit directly through the segment of exhaust pipe (9) without being cooled. Part of these non-cooled gases pass through the second inlet (17.1) of the bypass valve (17) to reach the EGR valve and part of the gases exit directly through the exhaust line.

This second end position of the flap (17.5) allows introducing hot exhaust gases in the EGR valve to prevent the occurrence of condensates when the engine is still cold after start up.

The existence of this EGR valve maintains a high degree of integration because:
the segment of exhaust pipe (9) on the side surface of which the second inlet (17.2) of the bypass valve (17) is located emerges after the second baffle (2) in a perpendicular arrangement,
the surface of the second casing (5) where the first inlet (17.1) of the bypass valve (17) is located is obliquely arranged and oriented towards the segment of exhaust pipe (9),
   such that both conditions give rise to a V-shaped cavity located in the convergence of the surface of the exhaust pipe (9) and the obliquely arranged surface of the second casing (5). The bypass valve (17) is located in this cavity for maintaining a high degree of assembly packaging.

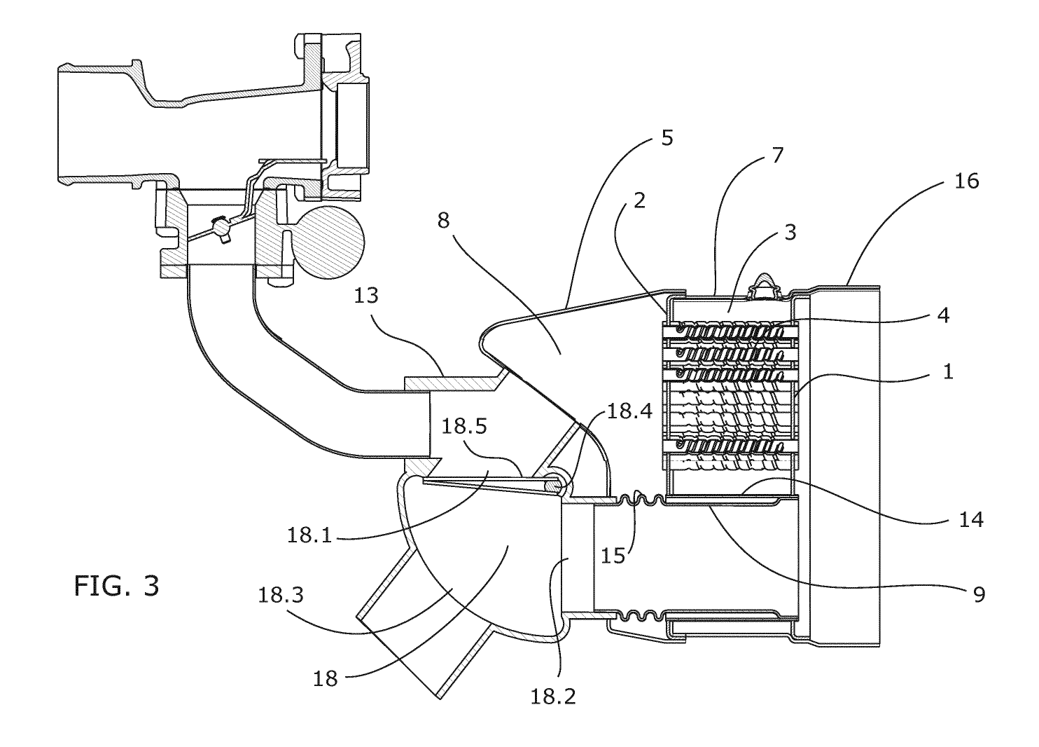

FIG. 3 shows a third embodiment comprising at least the elements described in the first embodiment as well as a heat recovery valve (18).

In this embodiment, the heat recovery valve (18) is a flap valve (18.5) with a rotating shaft (18.4) and two plates acting as a seat in a first inlet (18.1) or in a second inlet (18.2).

The first inlet (18.1) of the heat recovery valve (18) is in communication with the second cooled gas chamber (8) by means of a small segment of pipe which is shown to be oblique in FIG. 3. In turn, the cooled gas outlet (13) starts from this small segment so the cooled gas outlet for the exit of cooled gas towards the engine intake cannot be directly closed by the heat recovery valve (18).

The small oblique segment exits perpendicularly from a surface of the second casing (5) which is also obliquely arranged so that the small oblique segment is oriented towards the valve.

The second inlet (18.2) of the heat recovery valve (18) is directly fed by the outlet of the segment of exhaust (9), i.e., the entire flow circulating through the segment of exhaust pipe (9) feeds this second inlet (18.2).

The heat recovery valve (18) allows at least two end positions:
a first position where the first inlet (18.1) is contacted with the outlet (18.3) keeping the second inlet (18.2) closed; and,
a second position where the second inlet (18.2) is contacted with the outlet (18.3) keeping the first inlet (18.1) closed.

In the second end position there is no fluid communication between the second chamber (8) and the exhaust line so in this position the operating mode is similar to that of the first embodiment. In other words, the cooled gas is directed entirely to the engine intake and the gas exiting through the segment of exhaust pipe (9) is directed entirely to the exhaust line. The proportion of gas passing through the heat exchanger or through the segment of exhaust pipe (9) will depend on the degree of opening of the EGR valve.

In the first end position of the heat recovery valve (18) the exit through the segment of exhaust pipe (9) is blocked so all the gas exiting the particulate filter or the catalytic converter is forced to pass through the heat exchanger. By passing the entire flow through the heat exchanger, the transfer of heat to the coolant fluid is greater, successfully transferring most of the heat which would otherwise be emitted to the atmosphere to the coolant liquid circuit, for example, to reach the nominal temperature of the engine sooner when starting up.

In this particular case, the shaft (18.4) is located in the convergence of the oblique surface of the second casing (5) and the segment of exhaust pipe (9) emerging perpendicular to the first baffle (1) and second baffle (2).

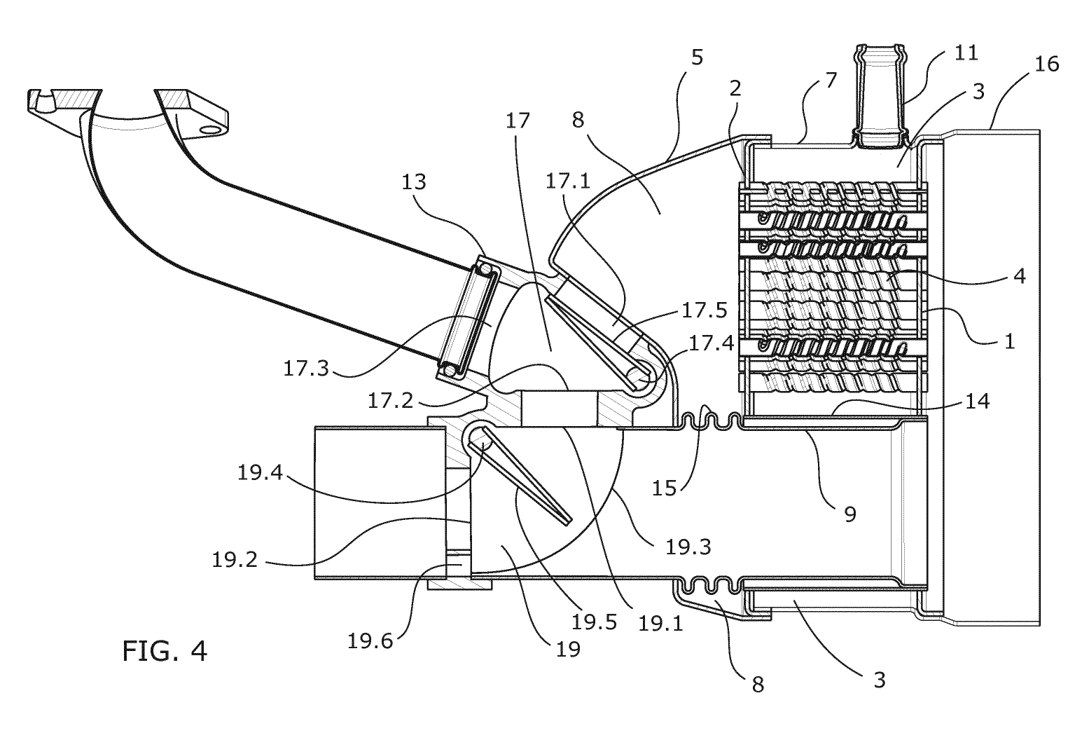

FIG. 4 shows a fourth embodiment comprising at least the elements described in the first embodiment as well as a bypass valve (17) and a heat recovery valve (18).

The bypass valve (17) is located in a location similar to that of the second embodiment and the heat recovery valve (19) is located in a location which has been described in the third embodiment.

Therefore, in addition to the elements described in the first example the device according to this embodiment comprises:
a bypass valve (17) with a first inlet (17.1) in connection with the second chamber (8), a second inlet (17.2) in connection with the segment of exhaust pipe (9); and an outlet (17.3) in communication with the cooled gas outlet (13) with access to the EGR valve where said bypass valve (17) allows at least two end positions:
   a first position where the first inlet (17.1) is contacted with the outlet (17.3) keeping the second inlet (17.2) closed; and,
   a second position where the second inlet (17.2) is contacted with the outlet (17.3) keeping the first inlet (17.1) closed
a second heat recovery valve (19) with a first outlet (19.1) in connection with the second inlet (17.2) of the bypass valve (17), an inlet (19.3) in connection with the end of the segment of exhaust pipe (9); and a second outlet (19.2) in communication with the exhaust line where said second heat recovery valve (19) allows at least two end positions:
   a first position where the inlet (19.3) is contacted with the first outlet (19.1) keeping the second outlet (19.2) closed; and,
   a second position where the inlet (19.3) is contacted with the second outlet (19.2) keeping the first outlet (19.1) closed.

When it is indicated that the second inlet (17.2) of the bypass valve (17) is in connection with the segment of exhaust pipe (9) in this embodiment, the connection is made through the first outlet (19.1) of the second heat recovery valve (19). According to this configuration, the passage between the inner chamber of one valve (17) and the other valve (19) is closed when any of the valves closes the passage, for example, if the bypass valve (17) closes the second inlet (17.2) or if the second heat recovery valve (19) closes the first outlet (19.1).

In this fourth embodiment, it is possible to have both the bypass function and heat recovery where it is necessary to coordinate the positions of one valve (17) and the other valve (19).

The position of the valves (17, 19) corresponding to the bypass valve (17) closing the second inlet (17.2) and the second heat recovery valve (19) closing the first outlet (19.1) shows a configuration operating in the same manner as the first embodiment.

FIG. 4 shows, below the seat of the second outlet (19.2), a passage (19.6) maintaining permanent communication between both sides even though the second heat recovery valve (19) is in the end position closing the second outlet (19.2). This passage (19.6) allows the engine to keep on running even though the second heat recovery valve (19) is completely closing the second outlet (19.2) and therefore closing the exhaust. The presence of this passage (19.6) is optional since the possibility of stopping the engine by completely closing the exhaust, for example in an emergency situation, may be desirable.

The position of the valves (17, 19) corresponding to the bypass valve (17) closing the second inlet (17.2) and the second heat recovery valve (19) closing the second outlet (19.2) shows a configuration operating in a manner similar to that performed by the third embodiment for heat recovery since almost the entire gas flow exiting the particulate filter or the catalytic converter is forced to pass through the heat exchanger. The difference thereof with respect to the third embodiment is that the existence of the passage (19.6) in the exhaust is that which would allow the exit of the exhaust gases, and these gases would not have passed through the heat exchanger, transferring their heat. A non-exclusive alternative to using the passage (19.6) is the use of intermediate positions of the second heat recovery valve (19). In intermediate positions, the exit of exhaust gases is still allowed and the degree of constriction is regulated to allow managing the amount of gas which is passed through the heat exchanger. It is said to be non-exclusive because it is possible to have the passage (19.6) and to also regulate the degree of constriction with intermediate positions of the second heat recovery valve (19). When these intermediate positions constrict the exhaust they favor exhaust gas recirculation in a manner proportional to the degree of closure of the second outlet (19.2).

The position of the valves (17, 19) corresponding to the bypass valve (17) closing the first inlet (17.1) and the second heat recovery valve (19) closing the first outlet (19.1) cancels out the heat exchanger forcing all the gas to exit through the exhaust line. This regulation is mainly the responsibility of the EGR valve. Nevertheless, if the EGR valve is closed, even though closing by means of the bypass valve (17) is redundant, if the EGR valve is not completely leak-tight the bypass valve (17) increases the leak-tightness, minimizing leakages.

The position of the valves (17, 19) corresponding to the bypass valve (17) closing the first inlet (17.1) and the second heat recovery valve (19) closing the second outlet (19.2) cancels out the heat exchanger forcing all the gas to enter the intake, for example, to prevent condensate formation.

As mentioned above, closing the second outlet (19.2) makes sense if there is a passage (19.6) which assures a minimum outlet flow towards the exhaust, and, alternatively, partial closing of the second outlet (19.2) using intermediate positions of the second heat recovery valve (19) makes sense. In addition to the bypass function, this particular solution has a regulated exhaust constricting function.

In the second and third embodiments, it is also of interest to use valves (17, 18) which allow intermediate positions located between the end positions.

It is of even greater interest to use intermediate positions in this fourth embodiment. For example, when the bypass valve (17) is in the first end position or in the second end position, the partial opening of the second heat recovery valve (19) constricts the outlet of the exhaust modifying the pressure and therefore either the amount of hot gas flow reintroduced in the intake or the amount of flow passing either towards the exchanger or towards the exhaust line.

In this fourth embodiment, the position of the shafts (17.4, 19.4) located in an alternate position at both sides of the communication between valves allow keeping the same degree of integration.

Particularly, the configuration verifies that:
the segment of exhaust pipe (9) where the connection of the second inlet (17.2) of the bypass valve (17) is located emerges after the second baffle (2) in a perpendicular arrangement, particularly through the second casing (5) when said segment of exhaust pipe (9) is housed in the second chamber (3),
the surface of the second casing (5) where the first inlet (17.1) of the bypass valve (17) is located is obliquely arranged and oriented towards the segment of exhaust pipe (9),
   where
the bypass valve (17) is made up of a flap (17.5) rotating about a shaft (17.4) which either closes the first inlet (17.1) or closes the second inlet (17.2) and is configured such that the shaft (17.4) is located in the cavity located in the convergence of the surface of the exhaust pipe (9) and the obliquely arranged surface of the second casing (5); and,
the second valve (19) is made up of a flap (19.5) rotating about a shaft (19.4) which either closes the first outlet (19.1) or closes the second outlet (19.2) and is configured such that its shaft (19.4) is located in opposition with respect to the position of the shaft (17.4) of the bypass valve (17) according to the longitudinal direction in which the segment of exhaust pipe (9) extends.

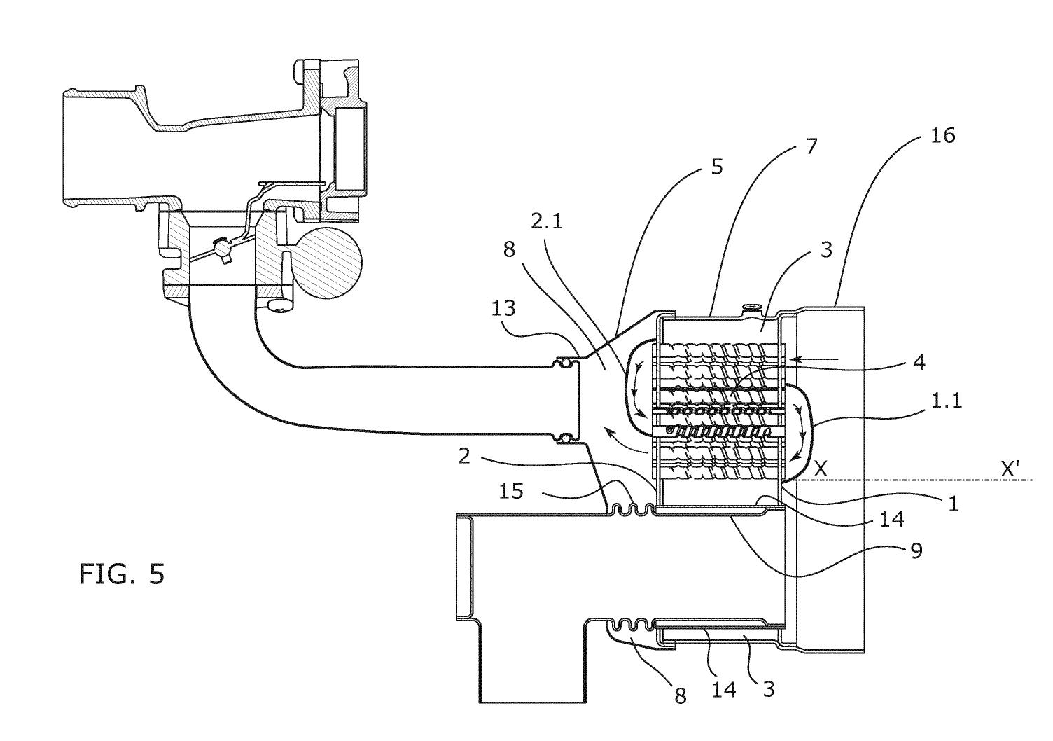

FIG. 5 shows the first embodiment where two hoods (1.1, 2.1) have been added, one in the first baffle (1) and another in the second baffle (2). Each hood (1.1, 2.1) covers the inlet or outlet of a set of ends of cooling pipes (4), preferably two thirds. Of these two thirds of the tubes, one third is covered on both sides by both hoods (1.1, 2.1). A one third proportion is suitable when the cooling pipes (4) have the same section, being able to be different if the sections of said pipes (4) are not the same.

In view of the auxiliary arrows showing the flow direction, to the right one third of the cooling pipes (4) is not covered by the first hood (1.1) located on the first baffle (1) and allows the entry of the flow coming from the particulate filter or from the catalytic converter. After a first passage through the first chamber (3), this flow reaches the inside of the second hood (2.1) located on the second baffle (2). The flow arrives through one third of the cooling pipes (4) and the second hood (2.1) redirects the flow to the other one third of the cooling pipes (4) that it is covering. This second one third of the cooling pipes (4) is that which is usually covered by both hoods (1.1, 2.1). The result is that the gas flow which has entered the exchanger passes through the first chamber (3) a second time. Finally, the first hood (1.1) redirects the flow towards the second chamber (8) again after a third passage through the first chamber (3) of the heat exchanger.

This solution can be extrapolated using an odd number of gas passages through the first chamber (3).

Even though this technical solution has been described using a modification of the first embodiment, the use of multiple passages through the heat exchanger is applicable to all the described embodiments.

According to this technical solution, when it is indicated that the cooling pipes (4) extend from the first baffle (1) to the second baffle (2) such that they communicate the outlet of the particle filter or catalytic converter with the second chamber (8) for the passage and cooling of the exhaust gases passing therethrough, it must be interpreted that they are communicated with one another either directly or indirectly when multiple passages through the exchanger are used.

In any of the examples, the device can also comprise an emergency filter for filtering solid particles such as ceramic particles. These filters can be arranged at the inlet of the device, at the outlet of the heat exchanger coinciding with the region where the cooling pipes (4) are located, at the second inlet of the bypass valve (17.2), at the gas outlet for gases intended for reaching the engine intake or in a combination of any of the above. One embodiment of this emergency filter is formed by a metal mesh covering the section of passage to be filtered.

In any of the embodiments, the control system for controlling the EGR system is that which determines the position of the valves depending on the parameters determining recirculated gas management.

1. A built-in exhaust gas management device characterized in that it comprises:
a first baffle (1) with coupling means (16) configured for surrounding the outlet of a particulate filter or a catalytic converter,
a second baffle (2) spaced from the first baffle (1),
a first perimetral casing (7) extending between the first baffle (1) and the second baffle (2) such that it defines a first chamber (3) intended for housing a coolant fluid,
a second casing (5) arranged covering at least part of the surface of the second baffle (2) opposite the surface oriented towards the first chamber (3) such that a second chamber (8) for collecting cooled exhaust gases is defined,
one or more cooling pipes (4) housed inside the first chamber (3) where each pipe (4) is attached at one end to the first baffle (1) and at the second end to the second baffle (2) such that it communicates the outlet of the particle filter or catalytic converter with the second chamber (8) for the passage and cooling of the exhaust gases passing therethrough,
an inlet (11) and an outlet (12) of the first chamber (3) for the passage of coolant fluid through the first chamber (3),
the first baffle (1) shows a first area in which the cooling pipes (4) are distributed and a second area free of cooling pipes (4); and,
a segment of exhaust pipe (9) attached to the first baffle (1) through the second area free of pipes (4) in communication with the outlet of the particulate filter or catalytic converter for the exit of exhaust gases,
where the second chamber (8) has a cooled gas outlet intended for reaching the engine intake.

2. The device according to claim 1, characterized in that the exhaust pipe (9) extends at least from the first baffle (1) to the second baffle (2) passing through the inside of the first chamber (3).

3. The device according to claim 2, characterized in that at least the surface of the segment of exhaust pipe (9) passing through the inside of the first chamber (3) is thermally insulated to prevent heat transfer from the exhaust gases to the coolant liquid.

4. The device according to claim 3, characterized in that the surface of the segment of exhaust pipe (9) passing through the inside of the first chamber (3) is housed inside a segment of pipe with greater dimensions (14) giving rise to a separation chamber separating the segment of exhaust pipe (9) and the first chamber (3).

5. The device according to claim 1, characterized in that the segment of exhaust pipe (9) passes through the inside of the second chamber (8).

6. The device according to claim 5, characterized in that the segment of exhaust pipe (9) housed inside the second chamber (8) comprises a portion configured in the form of a bellows (15) for absorbing expansion stresses.

7. The device according to claim 1, characterized in that both the cooling pipes (4) and the segment of exhaust pipe (9) are arranged essentially parallel to one another.

8. The device according to claim 1, characterized in that it comprises a bypass valve (17) with a first inlet (17.1) in connection with the second chamber (8), a second inlet (17.2) in connection with the segment of exhaust pipe (9); and the outlet in communication with the cooled gas outlet (13) with access to the EGR valve where said valve (17) allows at least two end positions:
a first position where the first inlet (17.1) is contacted with the outlet (17.3) keeping the second inlet (17.2) closed; and,
a second position where the second inlet (17.2) is contacted with the outlet (17.3) keeping the first inlet (17.1) closed.

9. The device according to claim 8, characterized in that:
the segment of exhaust pipe (9) on the side surface of which the second inlet (17.2) of the bypass valve (17) is located emerges after the second baffle (2) in a perpendicular arrangement, particularly through the second casing (5) when said segment of exhaust pipe (9) is housed in the second chamber (3),
the surface of the second casing (5) where the first inlet (17.1) of the bypass valve (17) is located is obliquely arranged and oriented towards the segment of exhaust pipe (9),
where the bypass valve (17) is made up of a flap (17.5) rotating about a shaft (17.4) which either closes the first inlet (17.1) or closes the second inlet (17.2) and is configured such that the shaft (17.4) is located in the cavity located in the convergence of the surface of the exhaust pipe (9) and the obliquely arranged surface of the second casing (5).

10. The device according to claim 1, characterized in that it comprises a heat recovery valve (18) with a first inlet (18.1) in connection with the second chamber (8), a second inlet (18.2) in connection with the end of the segment of exhaust pipe (9); and an outlet (18.3) in communication with the exhaust where said heat recovery valve (18) allows at least two end positions:
a first position where the first inlet (18.1) is contacted with the outlet (18.3) keeping the second inlet (18.2) closed; and,
a second position where the second inlet (18.2) is contacted with the outlet (18.3) keeping the first inlet (18.1) closed where the second chamber (8) keeps a cooled gas outlet (13) without passage through the heat recovery valve (18).

11. The device according to claim 10, characterized in that:
the segment of exhaust pipe (9) at the end of which the second inlet (18.2) of the heat recovery valve (18) is located emerges after the second baffle (2) in a perpendicular arrangement, particularly through the second casing (5) when said segment of exhaust pipe (9) is housed in the second chamber (3),
the surface of the second casing (5) where the first inlet (18.1) of the heat recovery valve (18) is located is obliquely arranged and oriented towards the segment of exhaust pipe (9),
where the heat recovery valve (18) is made up of a flap (18.5) rotating about a shaft (18.4) which either closes the first inlet (18.1) or closes the second inlet (18.2) and is configured such that the shaft (18.4) is located in the cavity located in the convergence of the surface of the exhaust pipe (9) and the obliquely arranged surface of the second casing (5).

12. The device according to claim 1, characterized in that it comprises:
a bypass valve (17) with a first inlet (17.1) in connection with the second chamber (8), a second inlet (17.2) in connection with the segment of exhaust pipe (9); and an outlet (17.3) in communication with the cooled gas outlet (13) with access to the EGR valve where said bypass valve (17) allows at least two end positions:
a first position where the first inlet (17.1) is contacted with the outlet (17.3) keeping the second inlet (17.2) closed; and,
a second position where the second inlet (17.2) is contacted with the outlet (17.3) keeping the first inlet (17.1) closed;
a second valve (19) with a first outlet (19.1) in connection with the second inlet (17.2) of the bypass valve (17), an inlet (19.3) in connection with the end of the segment of exhaust pipe (9); and a second outlet (19.2) in communication with the exhaust line where said second valve (19) allows at least two end positions:
a first position where the inlet (19.3) is contacted with the first outlet (19.1) keeping the second outlet (19.2) closed; and,
a second position where the inlet (19.3) is contacted with the second outlet (19.2) keeping the first outlet (19.1) closed.

13. The device according to claim 12, characterized in that:
the segment of exhaust pipe (9) where the connection of the second inlet (17.2) of the bypass valve (17) is located emerges after the second baffle (2) in a perpendicular arrangement, particularly through the second casing (5) when said segment of exhaust pipe (9) is housed in the second chamber (3),
the surface of the second casing (5) where the first inlet (17.1) of the bypass valve (17) is located is obliquely arranged and oriented towards the segment of exhaust pipe (9),
where
the bypass valve (17) is made up of a flap (17.5) rotating about a shaft (17.4) which either closes the first inlet (17.1) or closes the second inlet (17.2) and is configured such that the shaft (17.4) is located in the cavity located in the convergence of the surface of the exhaust pipe (9) and the obliquely arranged surface of the second casing (5); and,
the second valve (19) is made up of a flap (19.5) rotating about a shaft (19.4) which either closes the first outlet (19.1) or closes the second outlet (19.2) and is configured such that its shaft (19.4) is located in opposition with respect to the position of the shaft (17.4) of the bypass valve (17) according to the longitudinal direction in which the segment of exhaust pipe (9) extends.

14. The device according to claim 12 or 13, characterized in that the second valve (19) has a passage (19.6) communicating both sides of the second outlet (19.2) even if the flap (19.5) of the second valve (19) is closing said second outlet (19.2).

15. The device according to claim 8, where one or more valves allows intermediate positions between the two end positions.

16. The device according to claim 1, characterized in that the EGR valve is arranged in its outlet intended for reaching the engine intake.

17. The device according to claim 16, characterized in that when the device has a bypass valve (17), the EGR valve is integrated at the outlet (17.3) of said bypass valve.

18. The device according to claim 1, characterized in that it comprises at least a first hood (1.1) on the opening of part of the cooling pipes (4) of the first baffle (1) and a second hood (2.1) on the opening of part of the cooling pipes (4) on the second baffle (2) suitable for establishing an odd number of flow passages through the cooling pipes (4).

19. An EGR system comprising a device according to claim 1 and a control system for controlling the position of the valves of said device.
